(19) United States
(12) Patent Application Publication
(10) Pub. No.: US 2020/0302560 A1
(43) Pub. Date: Sep. 24, 2020

(54) GAS USE PLANNING METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/362,611

(22) Filed: Mar. 23, 2019

(51) Int. Cl. G06Q 50/06; G06Q 10/06; G06Q 50/04

(52) U.S. Cl. CPC G06Q 50/06; G06Q 50/04; G06Q 10/06315

(57) ABSTRACT

The present invention relates to the field of Internet of Things (IoT), and particularly provides a gas usage planning method based on a compound IoT and an IoT system. According to the gas usage planning method based on the compound IoT and the IoT system provided by the present invention, the gas usage of each workshop in an enterprise is planned in advance; and when a gas usage amount of a workshop is to reach a limit or is beyond the limit, a gas meter sends an alarm for prompting. Therefore, the phenomenon of gas waste in the workshop is restrained and the production cost of the enterprise is saved; and meanwhile, the energy is saved and the emission is reduced, thereby being beneficial to the environment.

### TECHNICAL FIELD

The present invention relates to the field of Internet of Things (IoT), and in particular to a gas usage planning method based on a compound IoT and an IoT system.

### BACKGROUND

An enterprise or a factory with large gas consumption, such as a ceramic manufacturing factory, a glass processing factory, a steel forging factory and a metallurgical factory, generally includes a plurality of workshops. Different workshops may have different production indicators in a unit time such as a month, and different production outputs generally require different gas amounts. At present, many enterprises face the phenomena of gas waste and abuse in workshops, and have no practicable and effective method for restriction and standardization.

### SUMMARY

In view of this, an objective of the present invention is to provide a gas usage planning method based on a compound IoT and an IoT system to standardize the phenomena of gas waste and abuse in workshops of an enterprise.

To this end, the technical solutions adopted by the present invention are as follows:

According to a first aspect, the present invention provides a gas usage planning method based on a compound IoT; the method is applied to an IoT system; the IoT system includes a user platform, a service platform, a management platform, a sensor network platform and a plurality of object sub-platforms; the plurality of object sub-platforms are disposed in an enterprise; the enterprise includes a plurality of workshops; each of the workshops includes one of the object sub-platforms; each of the object sub-platforms includes a gas meter, and the method includes: sending, by the user platform, production indicators of different workshops of the enterprise to the management platform via the service platform; calculating, by the management platform, according to the production indicators of the different workshops, estimated gas usage amounts of the different workshops via preset gas usage models; sending, by the management platform, the estimated gas usage amounts corresponding to the different workshops to gas meters corresponding to the different workshops via the sensor network platform; and when a difference value between a gas amount used before a workshop completes a production indicator and an estimated gas usage amount is smaller than a threshold, sending, by a gas meter corresponding to the workshop, an alarm message.

Further, before the step of sending, by the user platform, production indicators of different workshops of the enterprise to the management platform via the service platform, the method further includes: establishing, by the management platform, a gas usage model according to a historical production indicator of each workshop and a gas usage amount corresponding to each of the historical production indicators.

Further, the method includes: when a workshop completes a production indicator, sending, by a gas meter, an actual gas usage amount consumed by the workshop to complete the production indicator to the management platform via the sensor network platform; and

updating, by the management platform, a gas usage model according to the actual gas usage amount and the production indicator corresponding to the actual gas usage amount.

Further, the method includes: calculating, by the management platform, a gas saving rate of each workshop according to an actual gas usage amount of each workshop and a corresponding production indicator, and sorting gas saving rates of the plurality of workshops.

Further, the method includes: sending, by the management platform, a sorting result for the gas saving rates of the plurality of workshops to the user platform via the service platform so as to be viewed by a user conveniently.

According to a second aspect, the present invention provides an IoT system; the IoT system includes a user platform, a service platform, a management platform, a sensor network platform and a plurality of object sub-platforms; the plurality of object sub-platforms are communicatively connected with the management platform via the sensor network platform; the management platform is communicatively connected with the service platform; the service platform is communicatively connected with the user platform; the plurality of object sub-platforms are disposed in an enterprise; the enterprise includes a plurality of workshops; each of the workshops includes one of the object sub-platforms; and each of the object sub-platforms includes a gas meter, where the user platform sends production indicators of different workshops of the enterprise to the management platform via the service platform; the management platform is configured to calculate, according to the production indicators of the different workshops, estimated gas usage amounts of the different workshops via preset gas usage models, and send the estimated gas usage amounts corresponding to the different workshops to gas meters corresponding to the different workshops via the sensor network platform; and when a difference value between a gas amount used before a workshop completes a production indicator and an estimated gas usage amount is smaller than a threshold, a gas meter corresponding to the workshop sends an alarm message.

Further, the management platform is configured to establish a gas usage model according to a historical production indicator of each workshop and a gas usage amount corresponding to each of the historical production indicators.

Further, when a workshop completes a production indicator, a gas meter is further configured to send an actual gas usage amount consumed by the workshop to complete the production indicator to the management platform via the sensor network platform; and the management platform is further configured to update a gas usage model according to the actual gas usage amount and the production indicator corresponding to the actual gas usage amount.

Further, the management platform is configured to calculate a gas saving rate of each workshop according to an actual gas usage amount of each workshop and a corresponding production indicator, and sort gas saving rates of the plurality of workshops.

Further, the management platform is configured to send a sorting result for the gas saving rates of the plurality of workshops to the user platform via the service platform so as to be viewed by a user conveniently.

The present invention provides a gas usage planning method based on a compound IoT and an IoT system. The method is applied to the IoT system. The IoT system includes a user platform, a service platform, a management platform, a sensor network platform, and a plurality of object sub-platforms; the plurality of object sub-platforms are disposed in an enterprise; the enterprise includes a plurality of workshops; each of the workshops includes one of the object sub-platforms; and each of the object sub-platforms includes a gas meter. The method includes: sending, by the user platform, production indicators of different workshops of the enterprise to the management platform via the service platform; calculating, by the management platform, according to the production indicators of the different workshops, estimated gas usage amounts of the different workshops via preset gas usage models; sending, by the management platform, the estimated gas usage amounts corresponding to the different workshops to gas meters corresponding to the different workshops via the sensor network platform; and when a difference value between a gas amount used before a workshop completes a production indicator and an estimated gas usage amount is smaller than a threshold, sending, by a gas meter corresponding to the workshop, an alarm message. According to the gas usage planning method based on the compound IoT and the IoT system provided by the embodiments of the present invention, the gas usage of each workshop in the enterprise may be planned in advance; and when a gas usage amount of a workshop is to reach a limit or has already reached the limit, a gas meter sends an alarm for prompting. Therefore, the phenomena of gas waste and abuse in workshops are restrained effectively and the production cost of the enterprise is saved; and meanwhile, the energy is saved and the emission is reduced, thereby being beneficial to the environment.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates a compositional schematic diagram of an IoT system provided by an embodiment of the present invention;

FIG. 2 illustrates a flowchart of a gas usage planning method based on a compound IoT provided by an embodiment of the present invention; and

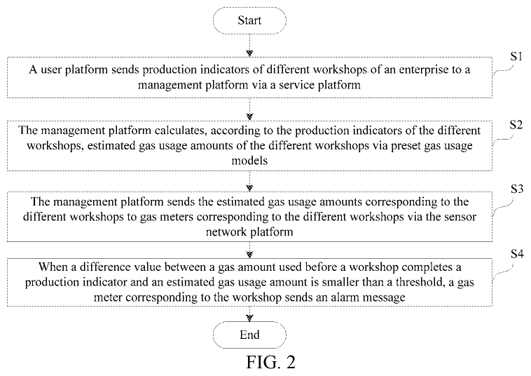

FIG. 3 illustrates a flowchart of a gas usage planning method based on a compound IoT provided by an embodiment of the present invention.

Numerals in the drawings: 100—IoT system; 10—user platform; 20—service platform; 30—management platform; 40—sensor network platform; 50—object sub-platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

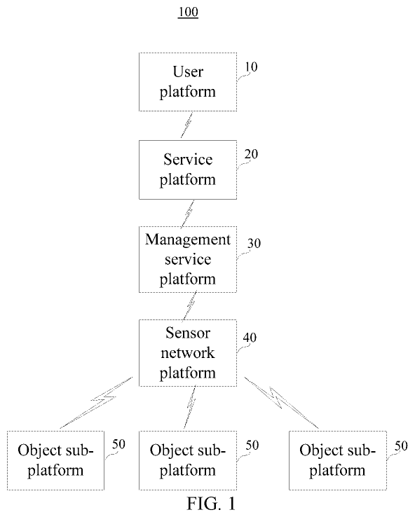

Referring to FIG. 1, a gas usage planning method based on a compound IoT provided by an embodiment of the present invention is applied to an IoT system 100. The IoT system 100 includes a user platform 10, a service platform 20, a management platform 30, a sensor network platform 40 and a plurality of object sub-platforms 50. Herein, the plurality of object sub-platforms 50 may be communicatively connected with the management platform 30 via the sensor network platform 40 to send data of the object sub-platforms 50 to the management platform 30, or receive a signal sent by the management platform 30. The management platform 30 is communicatively connected with the service platform 20. In this embodiment, the service platform 20 is a gas company service platform; and the service platform 20 is communicatively connected with the user platform 10, and is configured to receive information sent by the user platform 10, so as to send information sent by a user to the management platform 30 and push information sent by the management platform 30 to the user platform 10. The management platform 30 and the service platform 20 each may be a server. The gas usage planning method based on the compound IoT provided by this embodiment of the present invention is applied to planning the gas usage of an enterprise; the enterprise includes a plurality of workshops; each workshop includes one object sub-platform 50; and each of the object sub-platforms 50 includes a gas meter.

The gas usage planning method based on the compound IoT includes the following steps:

Step S1, a user platform sends production indicators of different workshops of an enterprise to a management platform via a service platform.

For a plurality of workshops of the enterprise, the production indicators in every month or every year mostly are different, e.g., a steel forging factory is provided with ten forging workshops, and the production indicators for the ten forging workshops in August 2017 were 100 tons, 90 tons, 95 tons, 80 tons, 65 tons, 70 tons, 85 tons, 75 tons, 60 tons and 110 tons respectively. After the production indicators are determined, the user platform 10 sends the production indicators of the workshops to the service platform 20, and then the service platform 20 forwards the production indicators to the management platform 30. In this embodiment, the user platform 10 may be a universal electronic device such as a Personal Computer (PC), a smartphone, a tablet computer, a Personal Digital Assistant (PDA), a Mobile Internet Device (MID). After a user enters a production indicator of each workshop on the user platform 10, the user platform 10 sends the production indicator of each workshop to the management platform 30 via the service platform 20. The user may be a manager of the enterprise.

Step S2, the management platform calculates, according to the production indicators of the different workshops, estimated gas usage amounts of the different workshops via preset gas usage models.

It is easily understood that different production indicators correspond to different gas demands, the gas demand corresponding to the high production indicator is high and the gas demand corresponding to the low production indicator is low. Upon the reception of the production indicators of the different workshops, the management platform 30 calculates, according to production outputs in the production indicators, an estimated gas usage amount required by each workshop to complete a corresponding production output, and the estimated gas usage amount is a gas usage amount planned for the workshop. In this embodiment of the present invention, each estimated gas usage amount is calculated via one gas usage model, and the gas usage model may be established in advance by the management platform 30 according to a historical production indicator of each workshop and a gas usage amount corresponding to the historical production indicator.

Step S3, the management platform sends the estimated gas usage amounts corresponding to the different workshops to gas meters corresponding to the different workshops via the sensor network platform.

In this embodiment, the sensor network platform 40 may be a gateway. The management platform 30 sends the calculated estimated gas usage amounts via the sensor network platform 40 to the gas meters corresponding to object sub-platforms 50 of the different workshops, so that the gas meters each can execute subsequent operations according to the estimated gas usage amounts.

Step S4, when a difference value between a gas amount used before a workshop completes a production indicator and an estimated gas usage amount is smaller than a threshold, a gas meter corresponding to the workshop sends an alarm message.

In practical application, the above threshold may be set freely as required, and may be, for example, set as required to alarm when the remaining gas amount is lower than 10%. If an excessive gas amount is used before a production indicator is completed by a workshop and there is few remaining gas amount, it is possible that the production indicator cannot be completed. In this case, a gas meter will send an alarm message to prompt a workshop producer or a person in charge to pay attention to the use of the gas. The alarm message may be a general buzzer alarm or flash lamp alarm, which is not defined thereto.

With the above steps, the gas usage planning method based on the compound IoT provided by this embodiment of the present invention may plan the gas usage of each workshop of the enterprise in advance; and when a gas usage amount of a workshop is to reach a limit or has already reached the limit, a gas meter gives an alarm to prompt, thereby effectively restricting the gas usage mount of the workshop.

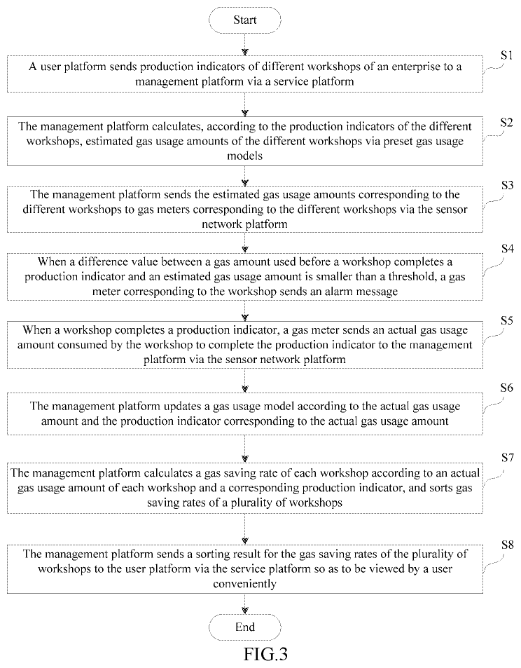

In addition, referring to FIG. 3, the gas usage planning method based on the compound IoT provided by this embodiment of the present invention may further include the following steps:

Step S5, when a workshop completes a production indicator, a gas meter sends an actual gas usage amount consumed by the workshop to complete the production indicator to the management platform via the sensor network platform.

It is to be noted that after a workshop completes a production indicator, a gas meter itself does not know when to send a gas usage amount, and needs to be operated (such as by pressing a button on the gas meter) by a workshop staff to send the data. The actual gas usage amount sent by the gas meter is a gas usage amount counted by the gas meter from a moment when the gas meter receives the estimated gas usage amount to a moment when the staff determines the completion of the production indicator.

Step S6, the management platform updates a gas usage model according to the actual gas usage amount and the production indicator corresponding to the actual gas usage amount.

Upon the reception of the actual gas usage amount consumed by each workshop to complete the production indicator, the management platform 30 brings the production indicator of each workshop and the corresponding actual gas usage amount to a gas usage model, and updates the data, so that the estimated gas usage amount corresponding to the production indicator can be more accurate in a later stage.

Step S7, the management platform calculates a gas saving rate of each workshop according to an actual gas usage amount of each workshop and a corresponding production indicator, and sorts gas saving rates of a plurality of workshops.

In order to motivate each workshop in the enterprise to save the gas and advocate energy conservation and emission reduction, after each workshop completes the production indicator, the management platform 30 counts the gas saving rate of each workshop. The gas saving rate may be calculated according to the following formula:

λ=(x−y)/x

where, λ is a gas saving rate, x is an estimated gas usage amount, and y is an actual gas usage amount.

The bigger the λ, the greater the effort that the workshop saves the gas. It is easily understood that if a gas saving rate λ of a workshop is negative, it is indicated that the actual gas usage amount of the workshop exceeds the estimated gas usage amount.

Step S8, the management platform sends a sorting result for the gas saving rates of the plurality of workshops to the user platform via the service platform so as to be viewed by a user conveniently.

By viewing the gas saving rates of the plurality of workshops, the user may know the production condition of each workshop. A workshop with a high gas saving rate may be commended and a workshop using the gas excessively may be criticized in a circulated notice, so that the phenomena of gas waste and abuse in workshops are restrained and the enterprise cost is saved; and meanwhile, the energy is saved and the emission is reduced, thereby being beneficial to the environment.

In conclusion, the embodiment of the present invention provides a gas usage planning method based on a compound IoT. The method is applied to an IoT system. The IoT system includes a user platform, a service platform, a management platform, a sensor network platform, and a plurality of object sub-platforms; the plurality of object sub-platforms are disposed in an enterprise; the enterprise includes a plurality of workshops; each of the workshops includes one of the object sub-platforms; and each of the object sub-platforms includes a gas meter. The method includes: the user platform sends production indicators of different workshops of the enterprise to the management platform via the service platform; the management platform calculates, according to the production indicators of the different workshops, estimated gas usage amounts of the different workshops via preset gas usage models; the management platform sends the estimated gas usage amounts corresponding to the different workshops to gas meters corresponding to the different workshops via the sensor network platform; and when a difference value between a gas amount used before a workshop completes a production indicator and an estimated gas usage amount is smaller than a threshold, a gas meter corresponding to the workshop sends an alarm message. According to the gas usage planning method based on the compound IoT and the IoT system provided by the embodiments of the present invention, the gas usage of each workshop in the enterprise may be planned in advance; and when a gas usage amount of a workshop is to reach a limit or has already reached the limit, a gas meter sends an alarm for prompting. Therefore, the phenomena of gas waste and abuse in workshops are restrained effectively and the production cost of the enterprise is saved; and meanwhile, the energy is saved and the emission is reduced, thereby being beneficial to the environment.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

What is claimed is:

1. A gas usage planning method based on a compound Internet of Things (IoT), wherein the method is applied to an IoT system; the IoT system comprises a user platform, a service platform, a management platform, a sensor network platform and a plurality of object sub-platforms; the plurality of object sub-platforms are disposed in an enterprise; the enterprise comprises a plurality of workshops; each of the workshops comprises one of the object sub-platforms; each of the object sub-platforms comprises a gas meter, and the method comprises:
sending, by the user platform, production indicators of different workshops of the enterprise to the management platform via the service platform;
calculating, by the management platform, according to the production indicators of the different workshops, estimated gas usage amounts of the different workshops via preset gas usage models;
sending, by the management platform, the estimated gas usage amounts corresponding to the different workshops to gas meters corresponding to the different workshops via the sensor network platform; and
when a difference value between a gas amount used before a workshop completes a production indicator and an estimated gas usage amount is smaller than a threshold, sending, by a gas meter corresponding to the workshop, an alarm message.

2. The gas usage planning method based on the compound IoT according to claim 1, wherein before the step of sending, by the user platform, production indicators of different workshops of the enterprise to the management platform via the service platform, the method further comprises:
establishing, by the management platform, a gas usage model according to a historical production indicator of each workshop and a gas usage amount corresponding to each of the historical production indicators.

3. The gas usage planning method based on the compound IoT according to claim 2, wherein the method further comprises:
when a workshop completes a production indicator, sending, by a gas meter, an actual gas usage amount consumed by the workshop to complete the production indicator to the management platform via the sensor network platform; and
updating, by the management platform, a gas usage model according to the actual gas usage amount and the production indicator corresponding to the actual gas usage amount.

4. The gas usage planning method based on the compound IoT according to claim 1, wherein the method further comprises:
calculating, by the management platform, a gas saving rate of each workshop according to an actual gas usage amount and a corresponding production indicator of each workshop, and sorting gas saving rates of the plurality of workshops.

5. The gas usage planning method based on the compound IoT according to claim 4, wherein the method further comprises:
sending, by the management platform, a sorting result for the gas saving rates of the plurality of workshops to the user platform via the service platform so as to be viewed by a user conveniently.

6. An Internet of Things (IoT) system, wherein the IoT system comprises a user platform, a service platform, a management platform, a sensor network platform and a plurality of object sub-platforms; the plurality of object sub-platforms are communicatively connected with the management platform via the sensor network platform; the management platform is communicatively connected with the service platform; the service platform is communicatively connected with the user platform; the plurality of object sub-platforms are disposed in an enterprise; the enterprise comprises a plurality of workshops; each of the workshops comprises one of the object sub-platforms; and each of the object sub-platforms comprises a gas meter, wherein:
the user platform sends production indicators of different workshops of the enterprise to the management platform via the service platform;
the management platform is configured to calculate, according to the production indicators of the different workshops, estimated gas usage amounts of the different workshops via preset gas usage models, and send the estimated gas usage amounts corresponding to the different workshops to gas meters corresponding to the different workshops via the sensor network platform; and
when a difference value between a gas amount used before a workshop completes a production indicator and an estimated gas usage amount is smaller than a threshold, a gas meter corresponding to the workshop sends an alarm message.

7. The IoT system according to claim 6, wherein the management platform is further configured to establish a gas usage model according to a historical production indicator of each workshop and a gas usage amount corresponding to each of the historical production indicators.

8. The IoT system according to claim 7, wherein when a workshop completes a production indicator, a gas meter is further configured to send an actual gas usage amount consumed by the workshop to complete the production indicator to the management platform via the sensor network platform; and the management platform is further configured to update a gas usage model according to the actual gas usage amount and the production indicator corresponding to the actual gas usage amount.

9. The IoT system according to claim 6, wherein the management platform is further configured to calculate a gas saving rate of each workshop according to an actual gas usage amount of each workshop and a corresponding production indicator, and sort gas saving rates of the plurality of workshops.

10. The IoT system according to claim 9, wherein the management platform is further configured to send a sorting result for the gas saving rates of the plurality of workshops to the user platform via the service platform so as to be viewed by a user conveniently.
